(19) United States
(12) Patent Application Publication
(10) Pub. No.: US 2025/0272684 A1
(43) Pub. Date: Aug. 28, 2025

(54) ENCRYPTION SYSTEM FOR PAYMENT SECURITY

(71) Applicant: XUHUI CAI, SINGAPORE (SG)

(72) Inventor: XUHUI CAI, SINGAPORE (SG)

(21) Appl. No.: 18/585,260

(22) Filed: Feb. 23, 2024

(51) Int. Cl. G06Q 20/40

(52) U.S. Cl. CPC G06Q 20/40145

(57) ABSTRACT

An encryption system for payment security is provided and includes: a payment end, a processing end, and a consumption end. The payment end comprises a facial data collection unit, a payment data generation unit, a signal conversion unit of the payment end, a data encryption unit of the payment end, a feedback data receiving unit. The processing end comprises a data decryption unit of the processing end, a payment data receiving unit, an image data receiving unit, a facial emotion recognition unit, a signal conversion unit of the processing end, a determination unit, and a data encryption unit of the processing end. In the present application, the facial data is collected during payment, the facial emotion of the user during payment is recognized, the security level of the surrounding payment environment is determined based on the state of the recognized facial emotion. In this way, payment security is ensured.

### TECHNICAL FIELD

The present disclosure relates to a technical field of payment security, and in particular to an encryption system for payment security.

### BACKGROUND

At present, as technologies develop, using terminals, such as mobile phones, to perform payment has become the most common way of consumption. Generally, mobile payment is performed by a mobile network of a mobile phone communicating with a server of a payment operator.

In the Chinese patent with the publication number of CN108764926B, a sound encryption payment method, a system, a user payment end, a payment operation service end are disclosed. For a key used in this patent, after the user payment end initiates a payment, a background noise of the user payment end and a background noise of the payment operation service end are changed in real time according to situations. The key is unknown to anyone and cannot be not easily decrypted. Therefore, security of the payment is achieved. However, since the encryption in the above patent is performed through background noises, authentication of the payment can be affected when the background noises are low and are difficult to be captured. Therefore, performance of the encryption may be limited.

### SUMMARY OF THE DISCLOSURE

The present disclosure provides an encryption system for payment security to solve the above technical problem mentioned in the Background section.

In a first aspect, the encryption system for payment security includes: a payment end, a processing end, and a consumption end. The payment end comprises a facial data collection unit, a payment data generation unit, a signal conversion unit of the payment end, a data encryption unit of the payment end, a feedback data receiving unit. The processing end comprises a data decryption unit of the processing end, a payment data receiving unit, an image data receiving unit, a facial emotion recognition unit, a signal conversion unit of the processing end, a determination unit, and a data encryption unit of the processing end. The consumption end comprises a data decryption unit of the consumption end, a payment data processing unit, and a payment feedback unit. The facial emotion recognition unit is configured to determine an emotion from facial data collected by the facial data collection unit; the determination unit is configured to predict, based on the determined emotion, whether a payment scenario is secure. The payment data processing unit is configured to perform a payment operation when the determination unit predicts that the payment scenario is secure; and the payment data processing unit is configured to stop the payment operation when the determination unit predicts that the payment scenario is unsecure.

In some embodiments, the payment data generation unit is configured to generate the payment data, and the facial data collection unit is initiated, when the user is performing payment, to collect the facial data of the user to generate facial image data.

In some embodiments, the signal conversion unit of the payment end is configured to convert the payment data and the facial image data into digital signals; the data encryption unit of the payment end is configured to encrypt the digital signals and send the encrypted digital signals to the data decryption unit of the processing end.

In some embodiments, the data decryption unit of the processing end, after receiving the encrypted digital signals sent from the data encryption unit of the payment end, is configured to decrypt the encrypted digital signals; retrieve the payment data and the facial image data; and send the payment data to the payment data receiving unit and send the facial image data to the image data receiving unit.

In some embodiments, the image data receiving unit is configured to send the facial image data to the facial emotion recognition unit; the facial emotion recognition unit is configured to recognize, by performing an emotion recognition method, a facial emotion of the user; and send the facial emotion to the determination unit; the determination unit is configured to perform determination on the facial emotion to generate determination-result data and send the determination-result data to the signal conversion unit of the processing end; and the payment data receiving unit is configured to send the payment data to the signal conversion unit of the processing end.

In some embodiments, the signal conversion unit of the processing end is configured to convert the payment data and the determination-result data into digital signals. The data encryption unit of the processing end is configured to encrypt the digital signals again and send the encrypted digital signals to the data decryption unit of the consumption end. The data decryption unit of the consumption end, after receiving the encrypted digital signals sent by the data encryption unit of the processing end, is configured to: decrypt the encrypted digital signals; and send the decrypted digital signals to the payment data processing unit. The payment data processing unit is configured to: obtain the payment data and the determination-result data based on the decrypted digital signals; perform a response for the payment data based on the determination-result data; and send a result of the response to the payment feedback unit.

In some embodiments, the payment feedback unit is configured to feed back the result of the response to the feedback data receiving unit.

According to the present disclosure, the facial data is collected during the payment, the facial expression of the user during the payment is recognized, and a security level of the surrounding payment environment is determined based on a state of the recognized facial expression. In this way, the security of the payment is ensured.

### BRIEF DESCRIPTION OF THE DRAWINGS

FIG. 1 is a block diagram of an encryption system for payment security according to one embodiment of the present disclosure.

Reference numerals in the drawing: 1: facial data collection unit; 2: payment data generation unit; 3: signal conversion unit of the payment end; 4: data encryption unit of the payment end; 5: feedback data receiving unit; 6: data decryption unit of the processing end; 7. payment data receiving unit; 8: image data receiving unit; 9: facial emotion recognition unit; 10: signal conversion unit of the processing end; 11. determination unit; 12, data encryption unit of the processing end; 13, data decryption unit of the consumption end; 14, payment data processing unit; 15, payment feedback unit.

### DETAILED DESCRIPTION

Technical solutions in the embodiments of the present disclosure will be described clearly and completely in the following by referring to the accompanying drawings of the present disclosure. Apparently, the described embodiments are only a part of but not all of the embodiments of the present disclosure. All other embodiments, which are obtained by any ordinary skilled person in the art based on the embodiments in the present disclosure without making creative work, shall fall within the scope of the present disclosure.

### Embodiments

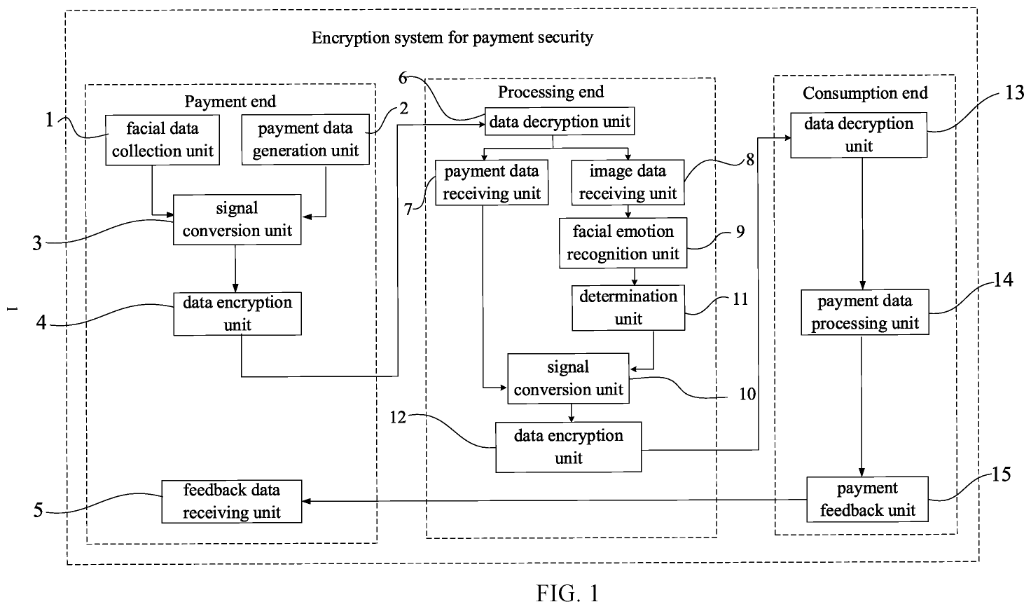

As shown in FIG. 1, an encryption system for payment security is provided and includes:
a payment end, a processing end, and a consumption end.

The payment end includes a facial data collection unit 1, a payment data generation unit 2, a signal conversion unit of the payment end 3, a data encryption unit of the payment end 4, a feedback data receiving unit 5. The processing end includes a data decryption unit of the processing end 6, a payment data receiving unit 7, an image data receiving unit 8, a facial emotion recognition unit 9, a signal conversion unit of the processing end 10, a determination unit 11, and a data encryption unit of the processing end 12. The consumption end includes a data decryption unit of the consumption end 13, a payment data processing unit 14, and a payment feedback unit 15.

The facial emotion recognition unit 9 is configured to determine an emotion from facial data collected by the facial data collection unit 1. The determination unit 11 is configured to predict, based on the determined emotion, whether a payment scenario is secure.

As shown in FIG. 1, the payment data generation unit 2 is configured to generate the payment data when a user is performing payment, and the facial data collection unit 1 is initiated to collect current facial data of the user to generate facial image data. The signal conversion unit 3 of the payment end is configured to convert the payment data and the facial image data into digital signals. The data encryption unit 4 of the payment end encrypts the digital signals. The encrypted digital signals are sent to the data decryption unit of the processing end 6.

The data decryption unit of the processing end 6, after receiving the encrypted digital signals sent from the data encryption unit of the payment end 4, decrypts the encrypted digital signals; retrieves the payment data and the facial image data; and sends the payment data to the payment data receiving unit 7 and sends the facial image data to the image data receiving unit 8. The image data receiving unit 8 sends the facial image data to the facial emotion recognition unit 9. The facial emotion recognition unit recognizes, by performing an emotion recognition method, a facial emotion of the user; and sends the facial emotion to the determination unit 11. The determination unit 11 performs determination on the facial emotion to generate determination-result data. The determination unit 11 sends the determination-result data to the signal conversion unit of the processing end 10, and the payment data receiving unit 7 sends the payment data to the signal conversion unit of the processing end 10. The signal conversion unit of the processing end 10 is configured to convert the payment data and the determination-result data into digital signals. The data encryption unit of the processing end 12 encrypts the digital signals again and send the encrypted digital signals to the data decryption unit of the consumption end 13.

The data decryption unit of the consumption end 13, after receiving the encrypted digital signals sent by the data encryption unit of the processing end 12, decrypts the encrypted digital signals and sends the decrypted digital signals to the payment data processing unit 14. The payment data processing unit 14 performs a response for the payment data based on the determination-result data. The payment data processing unit 14 sends a result of the response to the payment feedback unit 15. The payment feedback unit 15 is configured to feed back the result of the response to the feedback data receiving unit 5.

As described in the above, after the user sends a payment request, the payment data generation unit 2 generates the payment data, and at the same time, the facial data collection unit 1 collects the facial image data of the user at a current time point. The payment data and the facial image data are converted, encrypted, and decrypted, and subsequently, the facial emotion recognition unit 9 recognizes the emotion of the facial image data by performing the emotion recognition method. The determination unit 11 determines that the current emotion belongs to positive emotions or negative emotions. The determination-result data and the payment data generated are converted and encrypted again, and then sent to the data decryption unit of the consumption end 13 to be decrypted by the data decryption unit of the consumption end 13. The payment data processing unit 14 processes the payment data based on the determination-result data. When the determination-result data is that the current emotion belongs to the positive emotions, a payment operation is performed according to the payment data. When the determination-result data is that the current emotion belongs to the negative emotions, the payment operation is stopped. At last, a payment result is fed back to the user.

Specifically, the above emotion recognition method includes following operations.
(1) Image pre-processing: A motion-blur removing treatment and a noise-interference removing treatment are performed on original image data (obtained by the facial data collection unit 1 capturing a face the user). In this way, an influence on the facial image data caused by a signal-to-noise ratio is overcome. The image pre-processing operation performed on the original image data is completed, and a repaired clear image is obtained.
(2) Face feature extraction algorithm:

A facial image in the repaired clear image is converted into a labelled matrix Q. The matrix has a size of n*n, and a rank of the matrix is 1. The matrix has a w-ordered orthogonal matrix R and an o-ordered matrix. In this case, Q=ZRF^{T}.

Σ_{0*0}=diag(η₁, η₂, η₃, . . . , ηₙ) and the ηᵢ=\sqrt{uᵢ} is referred to as a singular value of the facial image. Key points of the facial image are matched with the singular value to obtain Q=ν₁p₁s₁^{T}+ν₂p₂s₂^{T}+ . . . +νₙapₙs₂^{T}.

In the above equation, the v represents linear values of a decomposition result of the singular value, and the pᵢsᵢ represents projection coefficient coordinates of the singular value in a preset image processing space.

The singular value is calculated based on Cₖᵢ^{j}=(gᵢ^{j})Qᵢ^{j}hᵢ^{j}.

The Cₖᵢ^{j} represents the i-th singular value of the c-th facial image of the j-th expression category. The gᵢ^{j} and the hᵢ^{j} represent vector values of two orthogonal matrices. The singular value of each expression category is extracted to serve as a feature value for each respective type of expression emotion.
(3) Determining and analyzing expression emotion:

The expression emotion is determined based on:

$$F ( \partial ) = \frac{{\partial }^{T} {X}_{i}^{I} \partial }{{\partial }^{T} {X}_{t}^{I} \partial } .$$

The xᵢ^{I} represents a discrete matrix of various facial-image-sample categories. The xₜ^{I} represents a discrete matrix of various facial image samples. The xⱼ^{I} represents a discrete matrix of various facial image samples within one category.

A face recognition formula is ∂= [symbol] (θ−ð) [symbol] .

The θ represents feature values of the facial image samples. The [symbol] represents a coefficient vector in the recognition process.

An object recognition function is E′=arg min ∥∂−∂ᵢ∥.

Based on the above formulas, facial expression emotion features are extracted and matched with the features of various types of the expression emotions of the facial images in an image database. In this way, the expression emotion of the face in the original image data is fuzzy-determined and analyzed. The facial emotion is recognized, and all facial emotions that can be recognized include hatred, happiness, curiosity, sadness, calmness, anger, and fear.

The determination unit 11 classifies the happiness, the curiosity, and the calmness as the positive emotions, and classifies the sadness, the anger, the hatred, and the fear as the negative emotions.

Although embodiments of the present disclosure have been shown and described, any ordinary skilled person in the art shall can perform various changes, modifications, substitutions and variations on the embodiments without departing from the principle and spirit of the present disclosure. The scope of the present disclosure is limited by the appended claims and equivalents thereof.

What is claimed is:

1. An encryption system for payment security, comprising:
a payment end, a processing end, and a consumption end;
wherein the payment end comprises a facial data collection unit, a payment data generation unit, a signal conversion unit of the payment end, a data encryption unit of the payment end, a feedback data receiving unit;
the processing end comprises a data decryption unit of the processing end, a payment data receiving unit, an image data receiving unit, a facial emotion recognition unit, a signal conversion unit of the processing end, a determination unit, and a data encryption unit of the processing end;
the consumption end comprises a data decryption unit of the consumption end, a payment data processing unit, and a payment feedback unit;
wherein the facial emotion recognition unit is configured to determine an emotion from facial data collected by the facial data collection unit; the determination unit is configured to predict, based on the determined emotion, whether a payment scenario is secure;
the payment data processing unit is configured to perform a payment operation when the determination unit predicts that the payment scenario is secure; and
the payment data processing unit is configured to stop the payment operation when the determination unit predicts that the payment scenario is unsecure.

2. The encryption system for payment security according to claim 1, wherein the payment data generation unit is configured to generate the payment data, and the facial data collection unit is initiated, when the user is performing payment, to collect the facial data of the user to generate facial image data.

3. The encryption system for payment security according to claim 1, wherein the signal conversion unit of the payment end is configured to convert the payment data and the facial image data into digital signals; the data encryption unit of the payment end is configured to encrypt the digital signals and send the encrypted digital signals to the data decryption unit of the processing end.

4. The encryption system for payment security according to claim 1, wherein the data decryption unit of the processing end, after receiving the encrypted digital signals sent from the data encryption unit of the payment end, is configured to decrypt the encrypted digital signals; retrieve the payment data and the facial image data; and send the payment data to the payment data receiving unit and send the facial image data to the image data receiving unit.

5. The encryption system for payment security according to claim 1, wherein the image data receiving unit is configured to send the facial image data to the facial emotion recognition unit; the facial emotion recognition unit is configured to recognize, by performing an emotion recognition method, a facial emotion of the user; and send the facial emotion to the determination unit; the determination unit is configured to perform determination on the facial emotion to generate determination-result data and send the determination-result data to the signal conversion unit of the processing end; and the payment data receiving unit is configured to send the payment data to the signal conversion unit of the processing end.

6. The encryption system for payment security according to claim 1, wherein the signal conversion unit of the processing end is configured to convert the payment data and the determination-result data into digital signals;
the data encryption unit of the processing end is configured to encrypt the digital signals again and send the encrypted digital signals to the data decryption unit of the consumption end;
the data decryption unit of the consumption end, after receiving the encrypted digital signals sent by the data encryption unit of the processing end, is configured to decrypt the encrypted digital signals and send the decrypted digital signals to the payment data processing unit;
the payment data processing unit is configured to obtain the payment data and the determination-result data based on the decrypted digital signals; perform a response for the payment data based on the determination-result data; and send a result of the response to the payment feedback unit.

7. The encryption system for payment security according to claim 1, wherein the payment feedback unit is configured to feed back the result of the response to the feedback data receiving unit.
